(19) United States
(12) Patent Application Publication
(10) Pub. No.: US 2004/0111352 A1
(43) Pub. Date: Jun. 10, 2004

(54) Method for providing the information on stock price

(76) Inventor: Euisu Kim, Seoul (KR)

Correspondence Address: Ladas & Parry, 26 West 61st Street, New York, NY, 10023, US

(21) Appl. No.: 10/700,103

(22) Filed: Nov. 3, 2003

(30) Foreign Application Priority Data
Nov. 15, 2002 (KR) KR10 2002 0071339

(51) Int. Cl. G06F 17/60

(52) U.S. Cl. 705/36

(57) ABSTRACT

This invention relates to a method for producing the Reasonable Stock Price of Stock Exchange listed-companies and providing clients with it in real time or at a regular time interval through an Internet site or mobile communication facilities wherein the Reasonable Stock Price reflects information about the changing of market environment in real time or at a regular time interval.

This invention comprises creating an Individual Company's Fundamentals Database; creating a Stock Price Indicator and Economic Indicator Database; producing a Reasonable Stock Price Valuation Index Database which reflects the created databases of Individual Company's Fundamentals, Stock Price Indicator and Economic Indicator; producing the Individual Company's Reasonable Stock Price from the Reasonable Stock Price Valuation Index Database; and providing a client information on the Reasonable Stock Price in real time or at a regular time interval through an Internet site or mobile communication network on the demand of clients.

### FIELD OF THE INVENTION

This invention relates to a method for producing Reasonable Stock Price of Stock Exchange listed-companies and providing clients with it in real time or at a regular time interval wherein the Reasonable Stock Price reflects the information of the market environment which is fluctuating in real time or at a regular time interval through an internet network. Also, this invention relates to a method for producing Reasonable Sector Index and Reasonable Composite Stock Price Index on the basis of the said Reasonable Stock Price of Stock Exchange listed-companies and providing clients with it in real time or at a regular time interval.

### BACKGROUND OF THE INVENTION

In recent years, stock market investors have increased continuously due to the interest in the Stock Exchange and to the expansion of the stock market. Thus, investors have increasingly demanded much information on stock prices which can bring them more profit.

Conventionally, investors have got information on stock prices by referring to an analyst's Company Valuation Report. As it were, analysts published Buying and Selling recommendation reports and individual investors traded stocks after referring to the target price, the prospects of the company and so on suggested in such reports.

With the development of Internet technology, information on stock price has begun to be provided through Internet website, for example, paxnet (www.paxnet.co.kr), thinkpool (www.thinkpool.co.kr) and so on, where for a fee experienced stock consultants provide investors with information on recommendations of Buying and Selling a certain company's stock through a website notice board, or mobile communication device. Accordingly, investors have traded stocks by referring to such information.

However, because the current valuation process of a company's Reasonable Stock Price has been based on the analyst's subjective opinion and diligence, the valuation has not quickly and properly reflected the fluctuation of the market environment and the economic alternation with the flow of time. Also, there have been little cases for an analyst to publish Report of selling a company's stock because an analyst usually is concerned about the objection from the company and the investors connected with the company. Therefore, the majority of valuation reports have been Buying recommendations giving good outlook on a company. Accordingly, although it has been easy for investor to access information for buying a company's stock by referring to a Buying recommendation report, they have had difficulty to get information for selling stocks, that is, selling time, selling price and the like.

Further, a great majority of information provided by Internet website has also been buying price, selling price and loss-cut price, and thus investors have not been provided with stock price information reflecting the fluctuation of market environment from the time of providing of information.

Furthermore, the stock price information provided in this way has usually been from consultants' subjective decision by simple factors of a company without the specific criterion on the fundamental evaluation of the company, and also, some stock price information has even been provided by unfair investment groups, thereby harming the user of the stock price information.

Also, the forecasting of the Composite Stock Price Index has been mainly provided in monthly or quarterly valuation figures, and there has been no providing of information about the valuation and forecasting of reasonable indexes of daily-changing Composite Stock Price Index, Sector Index, Futures index, Option Index and the information of Index-proportioned-Reasonable Stock Price based on the change of the Composite Index.

USP No. US2002152149 disclosed a method for providing information to customer just when the conditions of noticeable individual stock is satisfied with those to be input beforehand, such as the time when a stock price is changed into the special stock price, wherein the conditions include various technical indexes such as not only rising and falling stock prices but also comparison with the stock prices on the day before, the deviation rate from the transfer mean value, and RSI obtained from the psychological line. However, although the system disclosed in USP 149' has the benefit to reduce the effort of monitoring the stock price all the time by the client, it is little related to providing with an individual company's Reasonable Stock Price which fluctuated by the change of the Economic Indicators, Stock Price Indicators and a company's Fundamentals Indexes.

Also, KR application No. 20000014325 (Publication number KR2001089059) disclosed a method for providing customers with information on the stock price of a company by calculating the stock price from the company's Fundamentals database. However, this method does not reflect the Economic Indicators and Stock Price Indicators which are fluctuating in real time or at a regular time interval.

The applicant has overcome the defects of the conventional methods by i) producing the Stock Exchange-listed (or NASDAQ-registered) company's Reasonable Stock Price which reflects the fluctuation of market environment in real time or at a regular time interval and then providing clients with it in real time or at a regular time interval through an Internet site or mobile communication facilities; ii) producing the Reasonable Sector Index or Reasonable Composite Stock Price Index on the basis of the said produced Reasonable Stock Price and then providing clients with it; and iii) providing the Index-proportioned Reasonable Stock Price which is calculated in comparison with the fluctuation of the Composite Stock price index or NASDAQ composite index on the basis of the said Reasonable Stock Price.

### SUMMARY OF THE INVENTION

This invention relates to a method for producing the Reasonable Stock Price of Stock Exchange listed-companies and providing clients with it in real time or at a regular time interval through an Internet site or mobile communication facilities wherein the Reasonable Stock Price reflects information about the changing of market environment in real time or at a regular time interval. Also, this invention relates to a method for producing Reasonable Sector Index and Reasonable Composite Stock Price Index on the basis of the said Reasonable Stock Price of Stock Exchange listed-companies and providing clients with it in real time or at a regular time interval.

This invention comprises creating an Individual Company's Fundamentals Database; creating a Stock Price Indicator and Economic Indicator Database; producing a Reasonable Stock Price Valuation Index Database which reflects the created databases of Individual Company's Fundamentals, Stock Price Indicator and Economic Indicator; producing the Individual Company's Reasonable Stock Price from the Reasonable Stock Price Valuation Index Database; and providing a client information on the Reasonable Stock Price in real time or at a regular time interval through an Internet site or mobile communication network on the demand of clients.

### BRIEF DESCRIPTION OF THE DRAWINGS

FIG. 1 is a block diagram of the system for providing an Individual Company's Reasonable Stock Price according to the invention.

FIG. 2 is a flow chart of the process for producing the Individual Company's Reasonable Stock Price according to embodiment 1 of the invention.

FIG. 3 is a flow chart of the process for producing the Individual Company's Reasonable Stock Price Valuation Index according to embodiment 2 of the invention.

FIG. 4 is a block diagram of the system for producing the Reasonable Sector Index and Reasonable Composite Stock Price Index according to the invention.

FIG. 5 is a flow chart of the process for producing the Reasonable Sector Index according to embodiment 3 of the invention

FIG. 6 is a flow chart of the process for producing the Reasonable Composite Stock Price Index according to embodiment 4 of the invention.

100: Clients

400: Clients

102: Internet or Mobile communication facilities (device)

402: Internet or Mobile communication facilities (device)

104: Individual Company's Reasonable Stock Price Valuation Server

106: Individual Company's Fundamentals Database Server

108: Stock Price Indicator/Economic Indicator Database Server

404: Reasonable Sector Index/Composite Stock Price Index Valuation Server

406: Reasonable Sector Index Database

408: Reasonable Composite Stock Price Index Database

### DETAILED DESCRIPTION OF THE PREFERRED EMBODIMENTS

The following describes the constitution of this invention through preferred embodiments with reference to the provided drawings.

Embodiment 1

This embodiment relates to a method for providing an Individual Company's Reasonable Stock Price which reflects the fluctuation of the market environment with the flow of time.

The invention according to embodiment 1 comprises

i) the step of Individual Company's Fundamentals Database Server 106 creating Individual Company's Fundamentals Database which is fluctuating in real time or at a regular time interval;

ii) the step of Stock Price Indicator/Economic Indicator Database Server 108 creating Stock Price Indicator and Economic Indicator Database which is fluctuating in real time or at a regular time interval;

iii) the step of Individual Company's Reasonable Stock Price Valuation Server 104 being provided with Individual Company's Fundamentals Database from Individual Company's Fundamentals Database Server 106 and with Stock Price Indicator and Economic Indicator Database from Stock Price Indicator/Economic Indicator Database Server 108;

iv) the step of Individual Company's Reasonable Stock Price Valuation Server 104 producing Reasonable Stock Price Valuation Index Database by applying Individual Company's Fundamentals Database and Stock Price Indicator/Economic Indicator Database to the predetermined valuation algorithm;

v) the step of Individual Company's Reasonable Stock Price Valuation Server 104 producing Individual Company's Reasonable Stock Price from the above Reasonable Stock Price Valuation Index Database; and

vi) the step of Individual Company's Reasonable Stock Price Valuation Server 104 providing the produced Reasonable Stock Price to clients 100 through an Internet site or mobile communication facilities 102 in real time or at a regular time interval on the demand of clients 100.

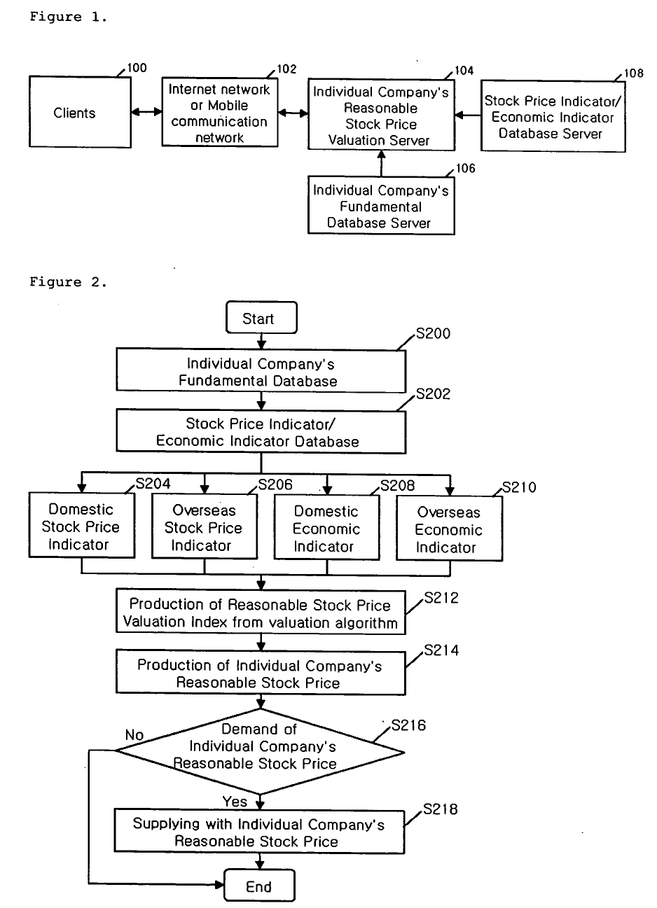

The system to perform the method for providing Individual Company's Reasonable Stock Price according to the invention, which is illustrated as a block diagram in FIG. 1, comprises Clients 100, Internet site or mobile communication facilities 102, Individual Company's Fundamentals Database Server 106 and Stock Price Indicator/Economic Indicator Database Server 108. As shown in the diagram, the Client 100, which uses PC (Personal Computer), Workstation or mobile communication device, is connected with an Individual Company's Reasonable Stock Price Valuation Server 104 through an Internet site or mobile communication facilities 102. For the convenience of the explanation, the diagram shows only one client 100, however, if necessary, a lot of clients can be set up.

Individual Company's Reasonable Stock Price Valuation server 104 is provided with an Individual Company's Fundamentals data from Individual Company's Fundamentals Database Server 106 and with Stock Price Indicator and Economic Indicator data by Stock Price Indicator/Economic Indicator Database Server 108, and then provides Client 100 with Reasonable Stock Price Valuation Service by reflecting the above data on Reasonable Stock Price to be produced.

Individual Company's Fundamentals Database Server 106 organizes a company's Fundamentals data, and then provides Individual Company's Reasonable Stock Price Valuation Server 104 with it. The company's Fundamentals data (Fundamentals Index) includes one or more elements selected from the group consisting of outstanding shares, equity capital, par value, sales, operating income, ordinary income, and net income for the last 10 years, assets, capital, liability, ration of financial expense to sales, debt ratio, quick ratio, PER (Price Earning Ratio), PBR (Price Book Value Ratio), PCR (Price Cash Flow Ratio), EPS (Earning Per Share), BPS (Book Value Per Share), and etc.

Stock Price Indicator/Economic Indicator Database Server 108 organizes Stock Price Indicator and Economic Indicator database, and then provides Individual Company's Reasonable Stock Price Valuation Server 104 with it.

Economic Indicator means such economic factors as interest rate, exchange rate, oil price, diffusion index (DI), coincident composite index (CCI), leading composite index (LCI), consumer price index (CPI), etc., and it can be classified into Domestic Economic Indicator and Overseas Economic Indicator.

Stock Price Indicator includes a stock price, Composite Stock Price Index and Sector Index which are evaluated by reflecting the above Economic Indicator on stock market, and it can be classified into Domestic Stock Price Indicator and Overseas Stock Price Indicator.

Domestic Stock Price Indicator comprises one or more elements selected from the group consisting of Dow-Jones index, NASDAQ composite index, S&P500 index, NASDAQ Futures index, S&P500 Futures index, Philadelphia semiconductor index, Goldman-Sachs internet index, all sorts of Sector Index data (Large capital stock, Medium capital stock, Small capital stock, Food Beverage and Tobacco, Textile and Wearing, Paper and Wood Products, Chemicals, Pharmaceuticals, Non-metal Products, Metal Products, Machinery, Electric and Electronics, Medical and Precision Machines, Transportation Equipment, Distribution, Electric & Gas, Construction, Transportation and Storage, Telecom, Banking, Securities, Insurance, Manufacturing, IT index, and etc.), Individual company's stock price, Option Index, trading volume, customer's deposit, data of NYSE (New York Stock Exchange) and etc., and Overseas Stock Price Indicator includes comprises one or more element selected from the group consisting of a stock price of other countries' Stock Exchange-listed companies (Germany, England, France, Japan, China, Korea, Taiwan and the like), and Composite Stock Price Index and Future Index of such a country.

Stock Price Indicator may additionally comprise one or more technical indexes selected from the group consisting of moving average, disparity, psychological line, OBV (On Balance Volume), VR (Volume Ratio), RSI (Relative Strength Index), Envelope, Bollinger Band, Parabolic SAR, Pivot Lines, MACD (moving average convergence divergence), Stochastics, DMS (directional movement system) and the like.

Domestic Economic Indicator comprises one or more elements selected from the group consisting of domestic interest rate, domestic bond interest rate, exchange rate, domestic oil price, domestic diffusion index (DI), domestic leading composite index (LCI), domestic coincident composite index (CCI), domestic consumer price index (CPI), domestic GDP growth rate, and Overseas Economic Indicator comprises one or more element selected from the group consisting of overseas interest rate, overseas bond interest rate, overseas exchange rate, overseas oil price, overseas diffusion index (DI), overseas leading composite index (LCI), overseas coincident composite index (CCI), overseas consumer price index (CPI), overseas GDP growth rate of each country, etc.

Individual Company's Fundamentals Database Server 106 and Stock Price Indicator/Economic Indicator Database Server 108 may be connected with other servers providing the above data such as a server used in Stock Exchange, and be able to automatically organize the above database in real time or at a regular time interval from server in Stock Exchange. Also, Servers 106 and 108 are able to organize the above database by directly inputting the data by hand at a regular time interval. Stock Price Indicator/Economic Indicator Database server 108 will be described in more detail on the flow chart of FIG. 2.

Individual Company's Reasonable Stock Price Valuation Server 104 is provided with the above data from Individual Company's Fundamentals Database Server 106 and Stock Price Indicator/Economic Indicator Database Server 108 in real time or at a regular time interval, and produces Individual Company's Reasonable Stock Price by applying the data to the predetermined valuation algorithm. Because the data undergoes a change by reflecting the fluctuation of the market environment with the time flow, the produced Individual Company's Reasonable Stock Price may also change, depending on the fluctuation of the data. Subsequently, Individual Company's Reasonable Stock Price Valuation Server 104 sends the valuated information of Individual Company's Reasonable Stock Price to clients 100 in real time or at a regular time interval through an Internet site or mobile communication network on the demand of clients.

The above valuated information includes Individual Company's Reasonable Stock Price, Index-proportioned Reasonable Stock Price, Reasonable Sector Index, Reasonable Composite Stock Price Index and Reasonable NASDAQ composite index as described below.

The above regular time interval may be from one hour to one month interval, preferably from one day to one week interval, more preferably, one day interval.

According to this invention, Individual Company's Reasonable Stock Price Valuation Server 104, Individual Company's Fundamentals Database Server 106, Stock Price Indicator/Economic Indicator Database Server 108 may be separated, respectively. However, it is desirable for Individual Company's Reasonable Stock Price Valuation Server 104 to comprise Individual Company's Fundamentals Database Server 106 and Stock Price Indicator/Economic Indicator Database Server 108 therein.

Embodiment 2

This embodiment describes the valuation process for producing Individual company's Reasonable Stock Price in detail by referring to the flow chart of FIG. 2.

First, in step S200, Individual Company's Reasonable Stock Price Valuation Server 104 is provided with Individual Company's Fundamentals Data such as the data of year quarterly, year half and yearly audited statement published by electronic publication system, for example, sales, operating income, ordinary income, and net income for last 10 years, assets, capital, liability, ration of financial expense to sales, debt ratio, quick ratio, PER (Price Earning Ratio), PBR (Price Book Value Ratio), PCR (Price Cashflow Ratio), EPS (Earning Per Share), BPS (Book Value Per Share) by Individual Company's Fundamentals Database server 106. In step S202, Individual Company's Reasonable Stock Price Valuation Server 104 is provided with the data of Stock Price Indicator and Economic Indicator by Stock Price Indicator/Economic Indicator Database Server 108. And, in step S204, Individual Company's Reasonable Stock Price Valuation Server 104 is provided with Domestic Stock Price Indicator Database; in step S206, server 104 is provided with Overseas Stock Price Indicator Database; in the step S208, server 104 is provided with Domestic Economic Indicator Database; in step S210, server 104 is provided with Overseas Economic Indicator Database; and in step S212, server 104 produces Reasonable Stock Price Valuation Index by applying the provided Individual Company's Fundamentals Database, Stock Price Indicator and Economic Indicator data to the valuation algorithm.

Reasonable Stock Price Valuation Index, which is the value produced by applying the above data to the valuation algorithm, is the basis to calculate Individual company's Reasonable Stock Price. This value may be changeable depending on the varied form of valuation algorithm to apply to, and those having an ordinary knowledge in the art to which the invention pertains may easily determine a reasonable valuation algorithm to produce Reasonable Stock Price.

The simplest form of valuation algorithm may be derived from comparing the individual company's PER and average PER of all companies in the sector which the individual company belongs to. However, because the valuation algorithm using only PER merely reflects the individual company's Fundamentals data, such an algorithm is not preferable, and it may be preferable to reflect both the Fundamentals data and Stock Price Indicator and Economic Indicator data. For example, the oil price and interest rate are generally in inverse proportion to stock price, and the customer's deposits and consumer confidence index are generally in proportion to stock price. Thus, such data may be additionally composed of the elements to be employed in the valuation algorithm.

Preferably, the valuation algorithm wherein the same values of Economic Indicator and Stock Price Indicator are reflected to a different degree on each company listed in a sector may be used in producing Individual Company's Reasonable Stock Price. For example, if company A had PER of 5-10 for the last 10 years and company B which belongs to the same sector as company A does had PER of 3-6, and PER of company B has increased twice due to the increase of the investment value of company B, the valuation algorithm may be prepared to differently reflect the same numerical value of Economic Indicator and Stock Price Indicator, as they are applied to the valuation algorithm twice in calculating company B's Reasonable Stock Price as much as in calculating company A's Reasonable Stock Price.

This relativity to be applied to the valuation algorithm in accordance with the investment value of the company can be extended to calculate each Sector Index. As it were, if sector A's average PER for the last 10 years was 5-10 and sector B's average PER for the last 10 years was 3-6, and sector B's average PER has increased twice due to the increase of the investment value of sector B, the valuation algorithm may be prepared to differently reflect the same numerical value of Economic Indicator and Stock Price Indicator data on sector A and sector B, respectively, as they are applied to the valuation algorithm twice in calculating sector B's Reasonable Sector Index as much as in calculating sector A's Reasonable Sector Index. Accordingly, the stock market investor can select the prospective sector group.

The Domestic Stock Price Indicator Database and Overseas Stock Price Indicator Database are the same as explained in embodiment 1.

In step S214, server 108 calculates Individual Company's Reasonable Stock Price from the produced Individual Company's Reasonable Stock Price Valuation Index. For example, if the produced Reasonable Stock Price Valuation Index is 0.8, the value of a current stock price*0.8 can be Individual Company's Reasonable Stock Price. In step S216, server 104 provides clients with the produced Individual Company's Reasonable Stock Price in real time or at a regular time interval through an Internet site or mobile communication device on the demand of clients.

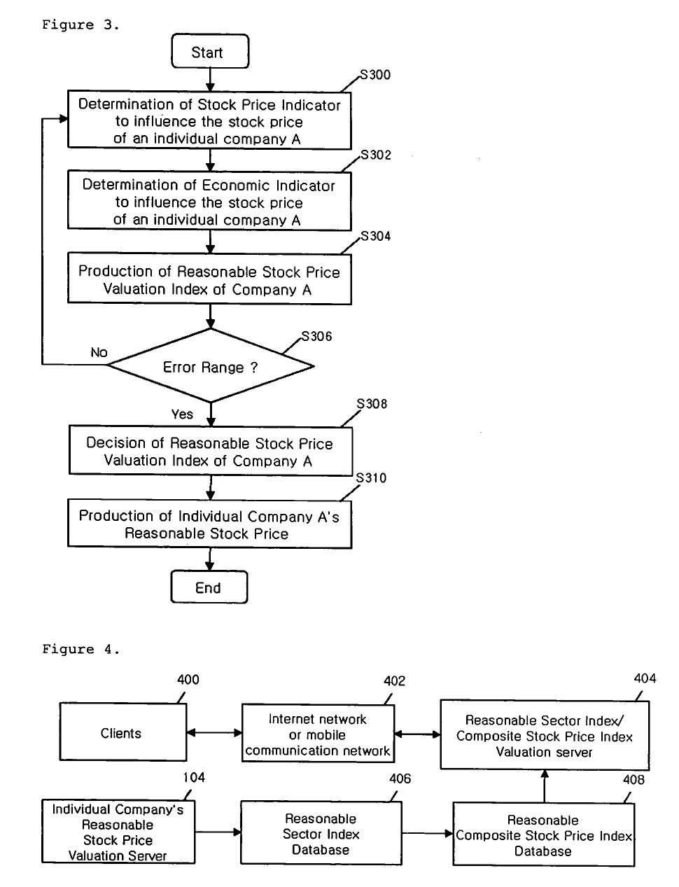

FIG. 3 shows more in detail the process for producing Reasonable Stock Price Valuation Index by the valuation algorithm in the course of evaluating Reasonable Stock Price of a company.

As shown in FIG. 3, in step S300, Individual Company's Reasonable Stock Price Valuation server 104 selects Stock Price Indicators to influence stock price of individual company A, and in step S302, selects Economic Indicators to influence the stock price of individual company A. In step S304, server 104 produces Individual Company's Reasonable Stock Price Valuation Index by applying the determined Stock Price Indicators and Economic Indicators to the valuation algorithm. Subsequently, in step S306, server 104 judges whether the produced Reasonable Stock Price Valuation Index is within an allowable error range or not.

The above allowable error range is the value used in judging whether Reasonable Stock Price driven from Individual Company's Reasonable Stock Price Valuation Index is effective for evaluating the stock price of individual company. For example, when the allowable error range is set as no more than 10%, if the Reasonable Stock Price Valuation Index of individual company A is 0.2 and the average Reasonable Stock Price Valuation Index of other companies in the sector is 0.3, the error rate, 33.3% ((0.3-0.2)/0.3*100), could be disregarded because it is away from the predetermined allowable error range of 10%. And if Reasonable Stock Price Valuation Index of individual company A is 0.27˜0.33, this would be allowed because it is within the allowable error range of 10%. The predetermined allowable error range can be set as 1-50%, preferably 5-30%, and more preferably 5-10% range, depending upon the reliability of the produced Reasonable Stock Price.

As the result of judgment in step S306, if Reasonable Stock Price Valuation Index is within an allowable error range, the process proceeds to the step S308 to fix individual company A's Reasonable Stock Price Valuation Index and proceeds to step S310 to construct Individual Company's Reasonable Stock Price Database.

As the result of judgment in step S306, if Reasonable Stock Price Valuation Index is over the predetermined allowable error range, the process returns to step S300 and server 104 re-determines the indexes to influence the stock price of individual company A. Such a course would be repeated until the created Reasonable Stock Price Valuation Index is within the allowable error range. Finally, when Reasonable Stock Price Valuation Index is produced within the allowable error range, the process proceeds to step S308 to fix the individual company A's Reasonable Stock Price Valuation Index and proceeds to step S310 to produce Individual Company's Reasonable Stock Price Database.

Embodiment 3

This embodiment describes the process for producing Reasonable Sector Index, Reasonable Composite Stock Price Index and Reasonable NASDAQ Composite Index on the basis of the produced Reasonable Stock Price of the Stock Exchange listed-companies through the embodiments 1 and 2, and providing clients with them in real time or at a regular time interval.

This embodiment comprises:

i) the step of Reasonable Sector Index/Composite Stock Price Index Valuation sever 404 being provided with Individual company's Reasonable Stock Prices which are produced through embodiments 1 and 2;

ii) the step of server 404 classifying each individual company into an individual sector group or a group forming Composite Stock Price Index or NASDAQ Composite Index, and determining the contribution rate of each individual company to Individual Sector Index, Composite Stock Price Index and NASDAQ Composite Index

iii) the step of server 404 producing Reasonable Sector Index or Reasonable Composite Stock Price Index or reasonable NASDAQ Composite Index by applying the above contribution rate to Reasonable Sector Index-, Composite Stock Price Index-, or Reasonable NASDAQ index-calculating algorithm.

iv) the step of server 404 providing clients 400 with the produced Reasonable Sector Index, Reasonable Composite Stock Price Index or Reasonable NASDAQ index in real time or at a regular time interval through an Internet site or mobile communication facilities 402 on the demand of clients 400.

FIG. 4 is a block diagram of the valuation system for producing Reasonable Sector Index or Reasonable Composite Stock Price Index. Reasonable Sector Index/Composite Stock Price Index Valuation server 404 selects the Reasonable Stock Price of an individual company which belongs to the individual sector group (for example, Large capital stock, Medium capital stock, Small capital stock, Food Beverage and Tobacco, Textile and Wearing, Paper and Wood Products, Chemicals, Pharmaceuticals, Non-metal Products, Metal Products, Machinery, Electric and Electronics, Medical and Precision Machines, Transportation Equipment, Distribution, Electric & Gas, Construction, Transportation and Storage, Telecom, Banking, Securities, Insurance, Manufacturing, IT index, Dow Jones 30 Industrials, Dow Jones 20 transportation, Dow Jones 15 Utilities, Fortune E-50, Frank Russell 3000, Frank Russell 2000, Frank Russell 1000, PHLX Semiconductor Index, NASDAQ Financial-100, NASDAQ Industrial, NASDAQ Transportation, NASDAQ Bank, NASDAQ Telecommunication, NASDAQ Insurance, NASDAQ Computer, NASDAQ Other Finance, NASDAQ Bio-technology, NASDAQ NM Industrial, and etc.) from Individual Company's Reasonable Stock Price Database which is constructed in embodiments 1 and 2, and then calculates Reasonable Sector Index of the individual sector group. Server 404 calculates all Reasonable Sector Indexes concerning all sector groups and constructs Reasonable Sector Index Database 406, and subsequently, provides clients with it in real time or at a regular time interval through an Internet site or mobile communication device 402.

Using the same method as above, server 404 may produce Reasonable Composite Stock Price Index from the produced Reasonable Stock Prices of all the companies listed in the Stock Exchange or all Reasonable Sector Indexes and may construct Reasonable Composite Stock Price Index database 408, and subsequently, provides clients with it in real time or at a regular time interval through an Internet site or mobile communication device 402. Also, being the same process as described above, server 404 may calculate Reasonable NASDAQ Composite Index from the produced Reasonable Stock Prices of all the companies registered in NASDAQ and provide clients with Reasonable NASDAQ Composite Index.

According to this invention, Reasonable Sector Index/Composite Stock Price Index Valuation Server 404 and Individual Company's Reasonable Stock Price Valuation Server 104 may be a separate server, respectively. However, it is desirable for Individual Company's Reasonable Stock Price Valuation Server 104 to comprise Reasonable Sector Index/Composite Stock Price Index valuation Server 404 therein. Also, if necessary, more servers corresponding to each Sector Index, Composite Stock Price Index, or NASDAQ composite index, can be set in the system for providing stock price information.

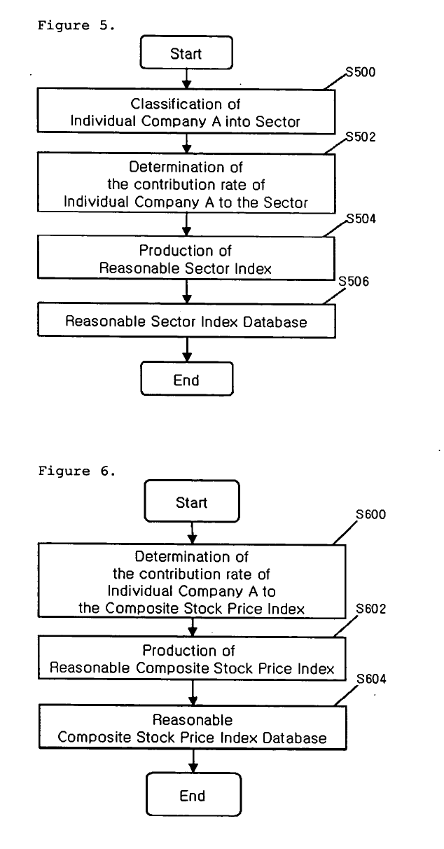

FIG. 5 is a detailed flow chart of the process for producing the Reasonable Sector Index database.

As shown in FIG. 5, in step S500, Reasonable Sector Index/Composite Stock Price Index Valuation Server 404 classifies each Individual Company's Reasonable Stock Price which is provided by server 104 into the sector to which the company belongs, and in step S502, server 404 determines the contribution rate of individual company A to the sector index. The contribution rate of individual company A is the value which is calculated from the proportion of company A's aggregate value of listed stock to the total aggregate value of all the companies which belong to the sector. Accordingly, the change of company A's actual stock price makes the change of the contribution rate of company A, and the contribution rate is generally used in calculating a sector index by a person skilled in the pertinent art. In step S504, server 404 produces Reasonable Sector Index by applying company A's contribution rate to the sector to Reasonable Sector Index-calculating algorithm, and constructs Reasonable Sector Index Database.

FIG. 6 is a detailed flow chart showing the process for producing Reasonable Composite Stock Price Index.

As shown in FIG. 6, in step S600, Reasonable Sector Index/Composite Stock Price Index Valuation Server 404 is provided with Reasonable Sector Index Database 406, and determines the contribution rate of each sector to Composite Stock Price Index. Subsequently, in step S602, server 404 calculates Reasonable Composite Stock Price Index by applying the contribution rate of the sector to Composite Stock Price Index to Reasonable Composite Stock Price Index-calculating algorithm, and constructs Reasonable Composite Stock Price Index Database. Such a valuation process can be equally applied to the construction of Reasonable NASDAQ Composite Index.

Embodiment 4

This embodiment relates to the method for providing Index-proportioned Reasonable Stock Price which is proportioned to the fluctuation of Composite Stock Price Index or NASDAQ Composite Index, on the basis of the produced Individual Company's Reasonable Stock Price.

The embodiment additionally comprises the step of producing Index-proportioned Reasonable Stock Price by applying Individual Company's Reasonable Stock Price which is produced in step (v) of embodiment 1 and the current Composite Stock Price Index or NASDAQ Composite Index to Index-proportioned Reasonable Stock Price-calculating algorithm, and subsequently, provides clients with it in real time or at a regular time interval through an Internet network or mobile communication facilities 102.

Index-proportioned Reasonable Stock Price means an individual company's stock price proportioned to Composite Stock Price Index or NASDAQ Composite Index of a future on the basis of the current Composite Stock Price Index and the current individual Company's Reasonable Stock Price, and is calculated by applying the current Composite Stock Price Index and the current individual company's Reasonable Stock Price to Index-proportioned Reasonable Stock Price-calculating algorithm.

The simplest form of Index-proportioned Reasonable Stock Price-calculating algorithm is for Individual Company's Reasonable Stock Price to be directly proportioned to Composite Stock Price Index or NASDAQ Composite Index. More preferably, Index-proportioned Reasonable Stock Price-calculating algorithm may be set with reflecting the relation between Composite Stock Price Index and the stock prices of the individual company for the last 10 years.

For example, when Index-proportioned Reasonable Stock Price-calculating algorithm that is directly proportioned to Composite Stock Price Index or NASDAQ composite index is used, if the current Composite Stock Price Index is 1,000 and the individual company A's Reasonable Stock Price is 10,000 won, Index-proportioned Reasonable Stock Price of company A are calculated to 7000 won, 8000 won, 9000 won, 11000 won, 12000 won, and 13000 won in proportion to the future Composite Stock Price Index 700, 800, 900, 1100, 1200, and 1300, respectively.

### PRACTICAL EXAMPLE

This example explains the process for producing Reasonable Stock Price of individual company A which belongs to Sector A′.

The Fundamentals data of the company A, and Stock Price Indicator and Economic Indicator from Oct. 5, 2002 to Oct. 9, 2002 are as follows:

| | Date | | | | |
|---|---|---|---|---|---|
| | 10.5 | 10.6 | 10.7 | 10.8 | 10.9 |
| Current stock price | 3800 | 4000 | 4200 | 4500 | 5100 |
| of company A | | | | | |
| Fundamentals data | | | | | |
| of company A | | | | | |
| EPS (year) | 2000 | 2000 | 2000 | 2000 | 2000 |
| PER (current) | 1.9 | 2.0 | 2.1 | 1.8 | 1.72 |
| PER (average past | 2.1 | 2.1 | 2.1 | 2.1 | 2.1 |
| 10 years) | | | | | |
| <Stock Price Indicator> | | | | | |
| Average PER of | 2.8 | 3.0 | 3.2 | 3.4 | 3.2 |
| Sector A′ | | | | | |
| Composite Stock | 995 | 998 | 985 | 990 | 1000 |
| Price Index | | | | | |
| <Economic Indicator> | | | | | |
| Domestic LCI (50 = 1) | 0.6 | 0.7 | 0.8 | 0.9 | 1.0 |
| Domestic CCI (50 = 1) | 0.7 | 0.8 | 0.9 | 1.0 | 1.1 |

The Reasonable Stock Price of company A was produced by applying this data to the following valuation algorithm:

<Reasonable Stock Price Valuation Algorithm>Reasonable Stock Price=Current stock price*Reasonable Stock Price Valuation Index=Current stock price*(average PER of sector A/current PER)*(average PER of past 10 years/current PER)*(today's composite stock price index/yesterday's composite stock price index)*CCI*LCI

=(EPS*current PER)*(average PER of sector A/current PER)*(average PER past 10 years/current PER)*(today's composite stock price index/yesterday's composite stock price index)*CCI*LCI

| | Date | | | | |
|---|---|---|---|---|---|
| | 10.5 | 10.6 | 10.7 | 10.8 | 10.9 |
| Current stock price | 3800 | 4000 | 4200 | 4500 | 5100 |
| Reasonable Stock Price | | 3539 | 4548 | 5103 | 5856 |
| Opinion | | − | + | + | + |

The preferable embodiments and practical example of this invention are described as the above. However, this invention is not limited to the above description, and may be performed in various modified forms within the knowledge of the pertinent art by a person having ordinary skill in the art.

### EFFECT OF THE INVENTION

As described above, this invention can suggest the criterion of investment to investors, decrease the risk of investment against the fluctuating market situation and makes the judging on an investment easier by providing Individual Company's Reasonable Stock Price, Reasonable Sector Index, Reasonable Composite Stock Price Index, Reasonable NASDAQ composite index and Index-proportioned Reasonable Stock Price which reflect the fluctuation of market situation.

Also, because S&P 500 index and NASDAQ composite index is the basis of Future index and Option index of S&P 500 and NASDAQ, this invention can provide an important investment standard to Future or Option investors.

What is claimed is

1. A method for providing stock price information, comprising the steps of:
i) Individual Company's Fundamentals Database Server 106 creating Individual Company's Fundamentals Database which is fluctuating in real time or at a regular time interval;
ii) Stock Price Indicator/Economic Indicator Database Server 108 creating Stock Price Indicator and Economic Indicator Database which is fluctuating in real time or at a regular time interval;
iii) Individual Company's Reasonable Stock Price Valuation Server 104 being provided with Individual Company's Fundamentals Database from Individual Company's Fundamentals Database Server 106 and with Stock Price Indicator and Economic Indicator Database from Stock Price Indicator/Economic Indicator Database Server 108;
iv) Individual Company's Reasonable Stock Price Valuation Server 104 producing Reasonable Stock Price Valuation Index Database by applying Individual Company's Fundamentals Database, and Stock Price Indicator and Economic Indicator Database to the predetermined valuation algorithm;
v) Individual Company's Reasonable Stock Price Valuation Server 104 producing Individual Company's Reasonable Stock Price from the above Reasonable Stock Price Valuation Index Database; and
vi) Individual Company's Reasonable Stock Price Valuation Server 104 providing the produced information on a stock price to clients 100 through an Internet site or mobile communication device 102 in real time or at a regular time interval on the demand of clients 100.

2. The method according to the claim 1, wherein the method further comprises the step of Individual Company's Reasonable Stock Price Valuation Server 104 selecting the Stock Price Indicators and Economic Indicators to influence stock price of the individual company.

3. The method according to the claim 1, wherein the method further comprises the step of Individual Company's Reasonable Stock Price Valuation Server 104 fixing Reasonable Stock Price Valuation Index if Reasonable Stock Price Valuation Index is within the predetermined allowable error range, or re-selecting Stock Price Indicator and Economic Indicator to influence stock price of the individual company if Reasonable Stock Price Valuation Index is not within the predetermined allowable error range.

4. The method according to the claim 3, wherein the allowable error range is from 5% to 10%.

5. The method according to the claim 1, the valuation algorithm is set up to reflect the same numerical value of Economic Indicator and Stock Price Indicator to a different degree on each company listed in a sector.

6. The method according to the claim, wherein the regular time interval is 1 day.

7. The method according to the claim 1, wherein Individual Company's Reasonable Stock Price Valuation Server 104 comprises Individual Company's Fundamentals Database Server 106 and Stock Price Indicator/Economic Indicator Database Server 108 therein.

8. The method according to the claim 1, wherein the method further comprises the step of Individual Company's Reasonable Stock Price Valuation Server 104 producing Index-proportioned Reasonable Stock Price by applying Individual Company's Reasonable Stock Price and the current Composite Stock Price Index or NASDAQ Composite Index to the predetermined Index-proportioned Reasonable Stock Price-calculating algorithm.

9. The method according to the claim 1, wherein the method further comprises the steps of:
i) Reasonable Sector Index/Composite Stock Price Index Valuation Sever 404 being provided with Individual company's Reasonable Stock Prices;
ii) Reasonable Sector Index/Composite Stock Price Index Valuation Sever 404 classifying each individual company into an individual sector group or a group forming Composite Stock Price Index or NASDAQ Composite Index, and determining the contribution rate of each individual company to the individual Sector Index, Composite Stock Price Index or NASDAQ Composite Index; and
iii) Reasonable Sector Index/Composite Stock Price Index Valuation Sever 404 producing Reasonable Sector Index, Reasonable Composite Stock Price Index or Reasonable NASDAQ Composite Index by applying the contribution rate to the Reasonable Sector Index/Composite Stock Price Index/Reasonable NASDAQ Composite Index-calculating algorithm.

10. The method according to the claim 1, wherein Individual Company's Fundamentals Database comprises one or more elements selected from the group consisting of outstanding shares, equity capital, par value, sales, operating income, ordinary income, and net income for last 10 years, assets, capital, liability, ration of financial expense to sales, debt ratio, quick ratio, PER (Price Earning Ratio), PBR (Price Book Value Ratio), PCR (Price Cashflow Ratio), EPS (Earning Per Share), BPS (Book Value Per Share);
Stock Price Indicator Database comprises one or more element selected from the group consisting of Dow-Jones index (30, 20, 15), NASDAQ composite index, S&P500 index, S&P100 index, NASDAQ Futures index, S&P500 Futures index, Philadelphia semiconductor index, Goldman-Sachs internet index, all sorts of Sector Index data (Large capital stock, Medium capital stock, Small capital stock, Food Beverage and Tobacco, Textile and Wearing, Paper and Wood Products, Chemicals, Pharmaceuticals, Non-metal Products, Metal Products, Machinery, Electric and Electronics, Medical and Precision Machines, Transportation Equipment, Distribution, Electric & Gas, Construction, Transportation and Storage, Telecom, Banking, Securities, Insurance, Manufacturing and IT index), an individual company's stock price, Option Index, trading volume, customer's deposit, a stock price of the Stock Exchange-listed companies in other countries (Germany, England, France, Japan, China, Korea, Taiwan and the like), and Composite Stock Price Index and Future Index of such countries; and
Economic Indicator Database comprises one or more element selected from the group consisting of interest rate, bond interest rate, exchange rate, oil price, diffusion index (DI), leading composite index (LCI), coincident composite index (CCI), consumer price index (CPI) and GDP growth rate.

11. The method according to the claim 10, wherein Stock Price Indicator further comprises one or more technical indexes selected from the group consisting of moving average, disparity, psychological line, OBV (On Balance Volume), VR (Volume Ratio), RSI (Relative Strength Index), Envelope, Bollinger Band, Parabolic SAR, Pivot Lines, MACD (Moving Average Convergence Divergence), Stochastics, and DMS (Directional Movement System).
